(19) United States
(12) Patent Application Publication
(10) Pub. No.: US 2006/0010610 A1
(43) Pub. Date: Jan. 19, 2006

(54) Conditioning method for improving polyamide cleanability and polyamides so conditioned

(76) Inventor: Daike Wang, Duncan, SC (US)

Correspondence Address: Charlotte C. Wilson;Legal Department, M-495, PO Box 1926, Spartanburg, SC, 29304, US

(21) Appl. No.: 10/891,368

(22) Filed: Jul. 14, 2004

(51) Int. Cl. C11D 3/00

(52) U.S. Cl. 8/115.51

(57) ABSTRACT

The present disclosure relates to a conditioning method in which at least one agent with a sulfonic group is added to polyamide fibers, via immersion and agitation in a low-pH solution, to improve the polyamide's characteristics. The agents may be stain-blocking agents, ultraviolet absorbing agents, or both. The sulfonic groups of these agents form ionic bonds with the polyamide, when the pH of the aqueous solution is lowered to the acidic range and, preferably, between 2 and 5. The rinse cycle of a washing machine, in which the pH of the rinse water has been lowered by the addition of acid, provides a particularly well-suited environment for the present reactive process, by providing a means for immersion and agitation of the polyamide-containing article. Polyamides subjected to low pH treatments of these agents exhibit a lower pH than polyamides treated with such agents during the steaming process.

### TECHNICAL FIELD

The present disclosure relates to a method for improving aesthetic characteristics of polyamide fibers, in which stain-blocking or ultraviolet-absorbing agents (or both) are added to the polyamide-containing article via immersion and agitation of the article in a low-pH solution containing one or both of these agents. The process of adding agents containing sulfonic groups in a low pH environment can occur subsequent to, or separately from, washing of the polyamide-containing article (but preferably occur as part of the rinse cycle). The resulting polyamide fibers exhibit improved functionality—in terms of resistance to staining, ultraviolet light, or both—as well as a lower pH than fibers treated by conventional methods.

### BACKGROUND

Polyamide fibers are commonly used to create textile articles because of their strength, flexibility, toughness, elasticity, abrasion resistance, washability, ease of drying, and resistance to attack by microorganisms. These fibers have been used in applications ranging from apparel (such as dresses, lingerie, stockings, and bathing suits) to industrial applications (such as industrial fabrics and tire cord) to carpets and other floor coverings. With most textile products, maintaining the appearance of the polyamide-containing article is of high importance to manufacturers and users thereof. In many instances, polyamide articles are treated with stain-blocking agents and/or ultraviolet absorbers during the manufacturing process, in an effort to preserve the original appearance of the article.

Such treatment is routinely used in the production of polyamide floor mats, as will be described further herein. Manufacturers of washable rubber-backed, dust-control mats often sell their mats to the textile rental industry, which then rents or sells the mats to end users such as retail stores, factories, hospitals, and the like. Typically, dust control mats—mats having a textile upper surface and a rubber or other solid backing—are placed in the entryways of a building or home. This placement is optimal for meeting the primary objectives of the mat, that being to clean the feet of crossing mat users and to maintain a clean adjacent flooring surface, thus preventing dirt and moisture from being transported onto adjacent surfaces that might become slippery when wet. In this environment, it is expected that the mat will become soiled from its normal use. On a predetermined frequency (e.g., weekly, monthly, etc.), the rental laundry service replaces the soiled mats with clean mats and returns the soiled mats to the laundry for cleaning.

Because of their durability and other features described above, polyamide fibers are most commonly used to make rubber-backed floor mats. Typically, these fibers are tufted into a primary backing material, such as a nonwoven fabric, and then are vulcanized to a rubber sheet material to form a mat with a polyamide pile surface and a rubber backing. To maintain the clean appearance of these mats, stain-blocking agents are applied, with the treated mats then being finished in a steamer at temperatures of about 100° C.

The problem with this approach, however, is that the ionic bond formed between the stain-blocking agent and the polyamide fiber is relatively weak. This is true of the bond formed between UV absorbers and polyamides as well, since UV absorbers also have reactive sulfonic groups. As a result, the stain-blocking agent (or UV absorber) is not strong enough to withstand regular use and repeated launderings, perhaps being significantly diminished after as few as five washes. When the stain-blocking agent has been washed away, the mat then becomes susceptible to both aqueous and oil-based stains encountered during use. For mats used in high traffic areas or outdoors, it is not unusual for the mats to become so dirty that they must be removed from rental circulation, after as few as twenty cycles. Likewise, when the UV absorber is washed away, the mat becomes susceptible to fading from exposure to UV light, thereby shortening its useful life.

The present treatment addresses these problems. By renewing the stain-blocking treatment and/or UV absorber periodically (for example, after each time the mat is washed), the useful life of the polyamide-containing article is extended. In the case of polyamide floor mats, their life may be extended up to at least one hundred cycles.

This renewal is achieved by adding the stain-blocking agent and/or UV absorber to an aqueous solution in which the article has been immersed and is subsequently agitated, in which the pH of the solution is acidic (i.e., 6 or less). Such immersion and agitation is easily achievable in the rinse cycle of a washing machine. When the present treatment occurs during the rinse cycle, the pH values that are used are significantly lower than those normally experienced in the wash cycle (typically, on the order of about 10 to about 12). At these low pH levels, the sulfonic groups of the stain-blocking agent and/or UV absorber form ionic bonds with the amine groups of the polyamide to create a stain-resistant and/or UV light-protected surface.

Another benefit of the present treatment when used in conjunction with the laundering process is the neutralization of the resulting wastewater. Whereas typical wash cycles have a pH in the range of 10 to 12 (basic on the pH scale) due to the high strength detergents used in rental laundries, the present process when incorporated into the rinse cycle is conducted at a pH of less than 6 (acidic on the pH scale). There is an overall neutralization effect created by the addition of an acidic solution to the rinse cycle, which eases the burden of the wastewater treatment process.

### SUMMARY

Stain-blocking agents and/or UV absorbers having sulfonic groups are applied to polyamide fibers by incorporating one or both of these additives as part of a process where the polyamide-containing article is immersed in an aqueous, low-pH environment in which it is subsequently agitated. One particularly well-suited environment for this process is the rinse cycle of a washing machine in which the pH has been lowered to an acidic level (i.e., preferably less than 6):

### DETAILED DESCRIPTION

The present process occurs in an aqueous solution at low pH, where the polyamide-containing article to be treated is immersed and subjected to agitation. The rinse cycle of a washing machine is an ideal setting for the present process to occur, although the present treatment can occur separately from the washing process and can occur in other environments where immersion and agitation can take place. Where the polyamide-containing article has been previously treated to impart stain and/or ultraviolet resistance, the present process serves as a renewal of the previous treatments.

Articles containing polyamide fibers specifically benefit from the present process because of the presence of amine groups that react with the sulfonic groups of the class of stain-blocking agents and/or ultraviolet absorbers contemplated for use within the present process. Although silk and wool are not ordinarily subjected to immersion to be laundered, it is contemplated that the present treatments would work equally well for those materials, which have similar amine groups as polyamides. Further, while it is preferable that the entire textile article be comprised of polyamide fibers, it should be understood that the present treatment improves the polyamide component of any textile article containing a combination of polyamide and other fibers.

One class of stain-blocking agents suitable for this application includes anionic surfactants having a relatively low molecular weight (MW in the range of 500 to 50,000) and containing sulfonic groups that react with nylon under low pH conditions. Examples of suitable stain-blocking agents are sold by. Minnesota Mining and Manufacturing Company (3M) of St. Paul, Minn., under the tradename STAINBLOCKER FC661 and by Milliken & Company of Spartanburg, S.C., under the tradenames FS2 and FS7.

One class of ultraviolet absorbers suitable for this application includes specific organic chromophores containing sulfonic groups that react with nylon under low pH conditions. Examples of suitable UV absorbers include benzatriazole sold by Ciba Specialty Chemical of High Point, N.C., under the tradenames CIBAFAST W and CIBAFAST AO.

The laundering process, especially as is used for polyamide floor mats, generally consists of a wash cycle, in which detergents raise the pH to the range of 10 to 12, followed by one or more rinse cycles, which are intended to remove the detergent from the articles (i.e., mats) and to dilute the high pH of the previously expelled wash water. Where multiple rinse cycles are used, the present treatment(s) are added to the final rinse cycle.

In practice, to lower the pH of the rinse water to the acidic range (that is, less than 6), an acidic solution must be added to the water. Preferably, the pH of the water is in the range of about 2 to about 5 and, more preferably, in the range of about 3 to about 4. Many acids are suitable for this purpose, with the amount of acid needed depending on the concentration of the acid being used. Examples of particularly useful acids include citric acid, sulfamic acid, and acetic acid, because of their relatively environmentally friendly nature and the relative ease with which they may be incorporated into the laundry setting.

The stain-blocking agent and/or UV absorber used in the present method may be added simultaneously with, or separately from, the acidic solution used to lower the pH of the rinse cycle. It has been found that the pH of the rinse cycle must be acidic in nature (and more preferably, in the 3-4 pH range) in order for the sulfonic groups of the stain-blocking agent and/or UV absorber to react with the amine groups of the polyamide fibers. If the pH is neutral or basic, no reaction will occur. The temperature of the solution used in the rinse cycle is not critical.

A consequence of the treatment of the polyamide in a low pH environment is that the polyamide fibers themselves have a lower pH than polyamide fibers that have been treated with similar chemistry in a steamer application. To measure the pH of the polyamide fibers treated with a stain-blocking agent in a steamer application and the pH of polyamide fibers treated with the immersion process described herein, 0.75 grams of nylon yarn were shaved from both a steamer-treated fiber and an immersion-treated fiber. The yarn shavings were each placed into a 20-gram glass vial. 15 grams of water were added to each vial, and the yarn was allowed to soak for 24 hours. The pH of the soaked nylon solutions was then measured using an Orion Model 420A pH meter. The results are shown below.

pH of NYLON FIBERS

| Sample | Process Conditions | Trial 1 | Trial 2 | Average |
|---|---|---|---|---|
| Mat A | Stain-blocking agent applied to mat | 7.68 | 7.63 | 7.66 |
| | and set with steamer | | | |
| | Laundered (wash; rinse; dry) with | | | |
| | detergent at wash cycle pH of 10 | | | |
| Mat B1 | Laundered (wash; rinse; dry) with | 6.21 | 6.20 | 6.21 |
| | detergent at wash cycle pH of 10 | | | |
| | 2% of the weight of the mat of | | | |
| | stain-blocking agent applied in the | | | |
| | rinse cycle at a pH of 3.5 for 3 | | | |
| | minutes | | | |
| Mat B2 | Laundered (wash; rinse; dry) with | 6.23 | 6.24 | 6.24 |
| | detergent at wash cycle pH of 10 | | | |
| | 20% of the weight of the mat of | | | |
| | stain-blocking agent applied in the | | | |
| | rinse cycle at a pH of 3.5 for 3 | | | |
| | minutes | | | |

These results show that the polyamide fibers treated with a stain-blocking agent in a low-pH rinse cycle (Mats B1 and B2) have a lower pH than those treated with similar chemistry and fixed in a steamer (Mat A).

When a stain-blocking agent is applied to polyamide fibers at an acidic pH (preferably, about 2 to about 5), the resulting treated polyamide fibers are capable of resisting stains that are aqueous in nature or that are oily in nature. This stain cleanability can be evaluated using AATCC Test Method 130-2000 entitled “Soil Release: Oily Stain Release Method.” In this test, a treated and untreated nylon mat were each stained with various contaminants. After 24 hours, the stained mats were washed in a standard industrial washer at 160° F., where the pH of the wash cycle was about 12. For the treated sample, the stain-blocking agent was reapplied during the rinse cycle after the wash, by reducing the pH of the rinse water to 3.5 and adding the stain-blocking agent.

The results are shown below, where 5.0 represents the best result and 1.0 represents the worst result.

Stain Cleanability Test (AATCC Method 130)

| STAIN SPECIFICATIONS | | CLEANABILITY RESULTS | |
|---|---|---|---|
| Contaminant | Diameter | Untreated | Treated |
| (amount used) | of Stain | Sample | Sample |
| Red Powdered | 5 cm | 1.0 | 5.0 |
| Drink Mix in solution | | | |
| (10 g; cold) | | | |
| Coffee | 5 cm | 2.0 | 4.0 |
| (10 g; cold) | | | |
| Burned Motor Oil | 2 cm | 2.0 | 4.0 |
| (1 g) | | | |

These results indicate that the stain blocking properties of the polyamide-containing article (in this case, a mat) can be successfully renewed with the incorporation of a stain-blocking agent into a low pH rinse solution. For each type of stain, the treated sample performed significantly better than the untreated sample.

In summary, the present method for improving cleanability of polyamide-containing articles includes incorporating a stain-blocking agent with a sulfonic group into a low-pH cycle of immersion and agitation (for example, as may occur in the rinse cycle of a typical washing process). Equally effective is the incorporation of a UV absorber, also with a sulfonic group, using similar low-pH conditions of immersion and agitation. In addition to improving the features of the treated polyamide-containing article, when used in conjunction with ordinary laundering processes, the low-pH rinse cycle technique described herein also facilitates the wastewater treatment process by neutralizing the relatively high pH levels used in the wash cycle. For these reasons, the present method and treated polyamide represent an advance over the prior art.

I claim:

1. A method for treating a textile article having fibers containing amine groups, said method comprising the steps of:
immersing said textile article in an aqueous solution having a pH of less than 6, in which at least one agent having a sulfonic group is present, and
agitating said low-pH solution to create bonds between the amine groups and the sulfonic groups.

2. The method of claim 1, wherein said agent having a sulfonic group is a stain-blocking agent.

3. The method of claim 1, wherein said agent having a sulfonic group is an ultraviolet absorber.

4. The method of claim 1, wherein a stain-blocking agent having a sulfonic group and an ultraviolet absorber having a sulfonic group are present in said low-pH solution.

5. The method of claim 1, wherein said steps of immersing and agitating occur in a washing machine.

6. The method of claim 5, wherein said at least one agent having having a sulfonic group is added to said washing machine during a rinse cycle.

7. The method of claim 5, wherein said textile article is washed before being immersed in said low-pH solution with said at least one agent having a sulfonic group.

8. The method of claim 7, wherein said at least one agent having a sulfonic group is added to said rinse cycle after each washing.

9. The method of claim 6, wherein an acid is added to said rinse cycle to lower the pH.

10. The method of claim 9, wherein said acid is citric acid.

11. The method of claim 9, wherein said acid and said agent having a sulfonic group are added simultaneously to said rinse cycle.

12. The method of claim 1, wherein the pH of said low-pH solution is between about 2 and about 5.

13. The method of claim 12, wherein the pH of said low-pH solution is between about 3 and about 4.

14. The method of claim 1, wherein said textile article is a fabric.

15. The method of claim 1, wherein said textile article is a floor mat.

16. The method of claim 1, wherein said textile article is comprised substantially of polyamide.

17. A polyamide fiber comprised of recurring amide groups, wherein at least some of amine groups on said fiber are ionically bonded to a sulfonic group and wherein said polyamide fiber having said sulfonic groups exhibits a pH of less than 7.0.

18. The polyamide fiber of claim 17, wherein said fiber exhibits a pH of less than 6.5.

19. The polyamide fiber of claim 17, wherein said sulfonic groups are part of a stain-blocking agent that imparts stain resistance to said fiber.

20. The polyamide fiber of claim 17, wherein said sulfonic groups are part of an ultraviolet absorbing agent that imparts ultraviolet resistance to said fiber.
